(19) United States
(12) Patent Application Publication
(10) Pub. No.: US 2005/0053771 A1
(43) Pub. Date: Mar. 10, 2005

(54) Indoor decorative paper and decoration method thereof

(76) Inventor: Tong-Ki Kim, Kyunggi-do (KR)

Correspondence Address: GREENBLUM & BERNSTEIN, P.L.C., 1950 ROLAND CLARKE PLACE, RESTON, VA, 20191, US

(21) Appl. No.: 10/808,394

(22) Filed: Mar. 25, 2004

(30) Foreign Application Priority Data
Sep. 9, 2003 (KR) 10-2003-0063437

(51) Int. Cl. B32B 9/00

(52) U.S. Cl. 428/195.1

(57) ABSTRACT

The present invention relates to indoor decorative papers of walls and ceilings, more specifically, to indoor decorative papers, wallpaper for example, of walls and ceilings in different patterns or designs: i.e., wallpapers with distinctive patterns between upper and lower parts; and ceiling papers with no distinctive patterns between upper and lower parts, or even without patterns.

### RELATED APPLICATIONS

The present disclosure relates to subject matter contained in priority Korean Application No. 10-2003-0063437, filed on Sep. 9, 2003, which is herein expressly incorporated by reference in its entirety.

### BACKGROUND OF THE INVENTION

1. Field of the Invention

The present invention relates in general to indoor decorative papers of walls and ceilings, more specifically, to indoor decorative papers, wallpaper for example, of walls and ceilings in different patterns or designs: i.e., wallpapers with distinctive patterns between upper and lower parts; and ceiling papers with no distinctive patterns between upper and lower parts, or even without patters.

2. Description of the Related Art

In general, wallpaper is made of paper, and used for decorating walls as a finishing material. Also, wallpaper is used for decorating ceilings as a finishing material. Typically, the wallpaper is pasted on walls and ceilings through an adhesive, and the wallpaper pattern for both places usually have identical designs.

When the wallpaper with the same design is applied to walls and ceilings, however, people might have a feeling of dullness and perceive the environment rather to be very formal. Further, some people even feel insecure by this inharmonically designed wallpaper.

### SUMMARY OF THE INVENTION

It is, therefore, an object of the present invention to provide indoor decorative papers of walls and ceilings in different patterns, whereby people can feel calm and peaceful at this new decoration method, and as a result, the indoor environment becomes friendlier.

To achieve the above object, there is provided an indoor decorative paper to be pasted on walls and ceilings, and being composed of wallpapers with distinctive patterns between upper and lower parts; and ceiling papers with no distinctive patterns between upper and lower parts, or even without patters.

Another aspect of the invention provides a decoration method using an indoor decorative paper, the method includes the steps of: applying an adhesive to a wallpaper with distinctive patterns between upper and lower parts; pasting the wallpaper upon indoor walls; applying an adhesive to a ceiling paper with no distinctive patterns between upper and lower parts or without patterns; and pasting the ceiling paper upon indoor ceilings.

### BRIEF DESCRIPTION OF THE DRAWINGS

The above objects, features and advantages of the present invention will become more apparent from the following detailed description when taken in conjunction with the accompanying drawings, in which:

FIG. 1 illustrates a first embodiment of a ceiling paper to which the present invention is applied;

FIG. 2 illustrates a second embodiment of a ceiling paper to which the present invention is applied;

FIG. 3 illustrates a third embodiment of a ceiling paper to which the present invention is applied;

FIG. 4 illustrates a fourth embodiment of a ceiling paper to which the present invention is applied;

FIG. 5 illustrates a fifth embodiment of a ceiling paper to which the present invention is applied;

FIG. 6 illustrates a sixth embodiment of a ceiling paper to which the present invention is applied;

FIG. 7 illustrates a seventh embodiment of a ceiling paper to which the present invention is applied;

FIG. 8 illustrates an eighth embodiment of a ceiling paper to which the present invention is applied;

FIG. 9 illustrates a first embodiment of wallpaper to which the present invention is applied;

FIG. 10 illustrates a second embodiment of wallpaper to which the present invention is applied;

FIG. 11 illustrates a third embodiment of wallpaper to which the present invention is applied;

FIG. 12 illustrates a fourth embodiment of wallpaper to which the present invention is applied;

FIG. 13 illustrates a fifth embodiment of wallpaper to which the present invention is applied;

FIG. 14 illustrates a sixth embodiment of wallpaper to which the present invention is applied;

FIG. 15 illustrates a seventh embodiment of wallpaper to which the present invention is applied;

FIG. 16 illustrates an eighth embodiment of wallpaper to which the present invention is applied; and

FIG. 17 illustrates an embodiment of indoor decoration to which an indoor decorative paper of the invention is applied.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

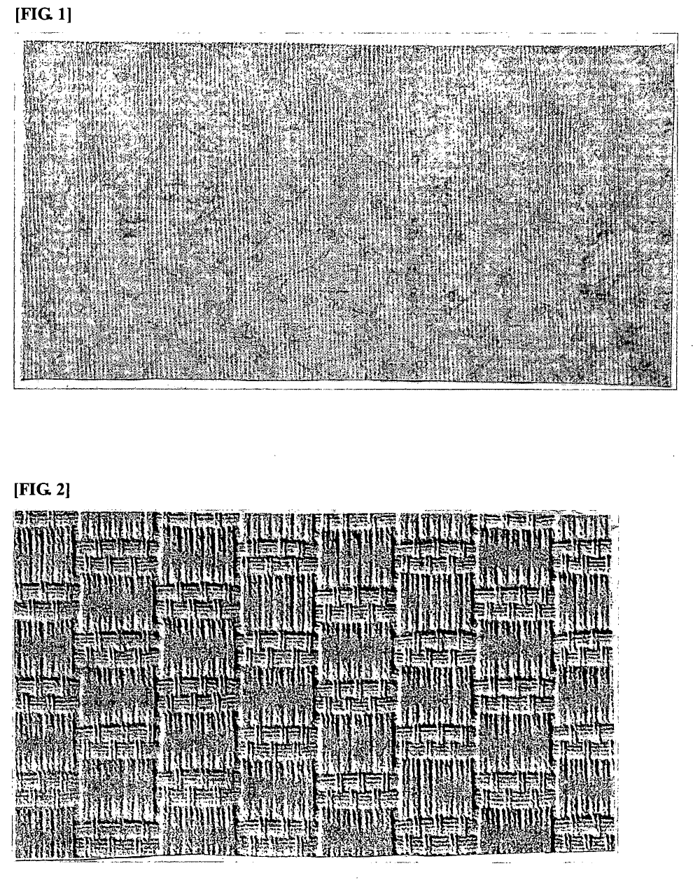

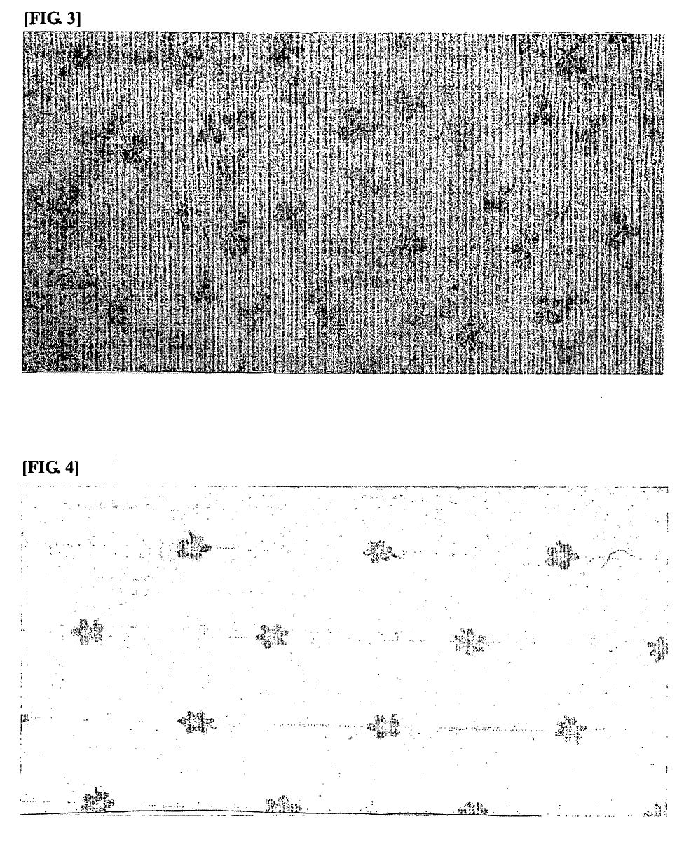

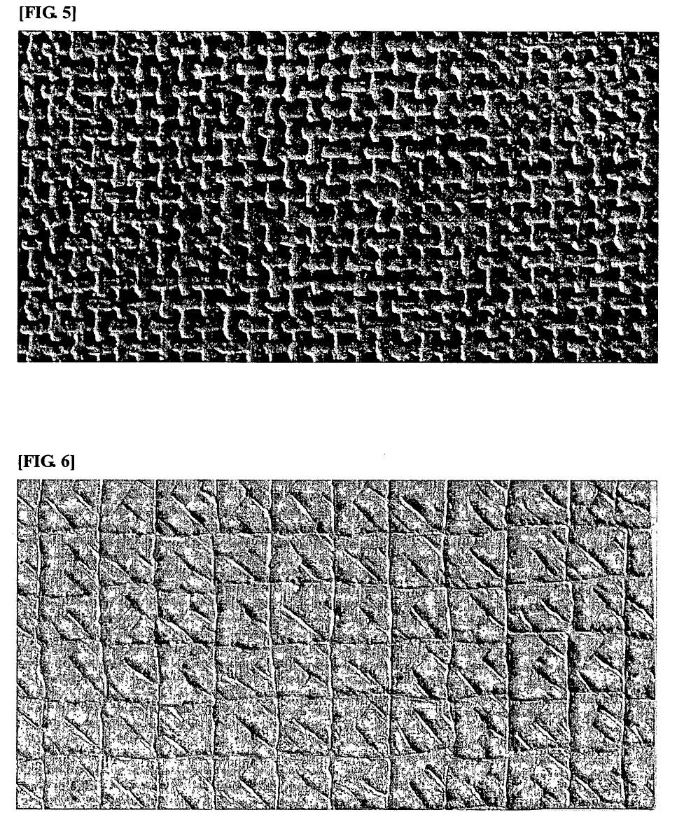

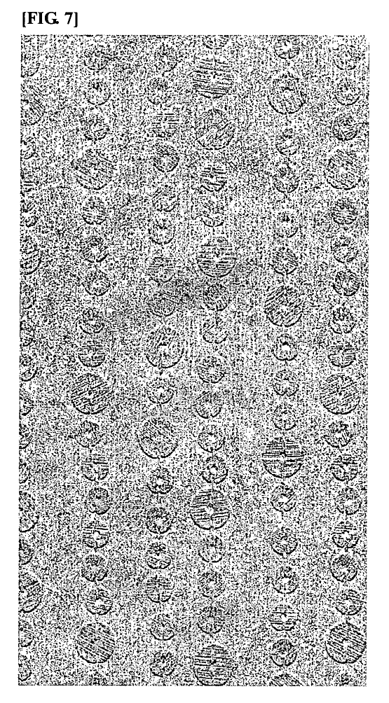

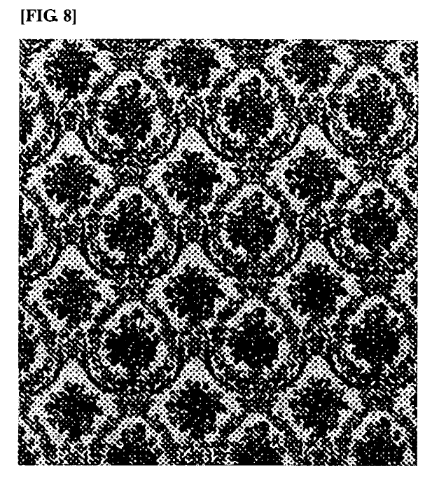

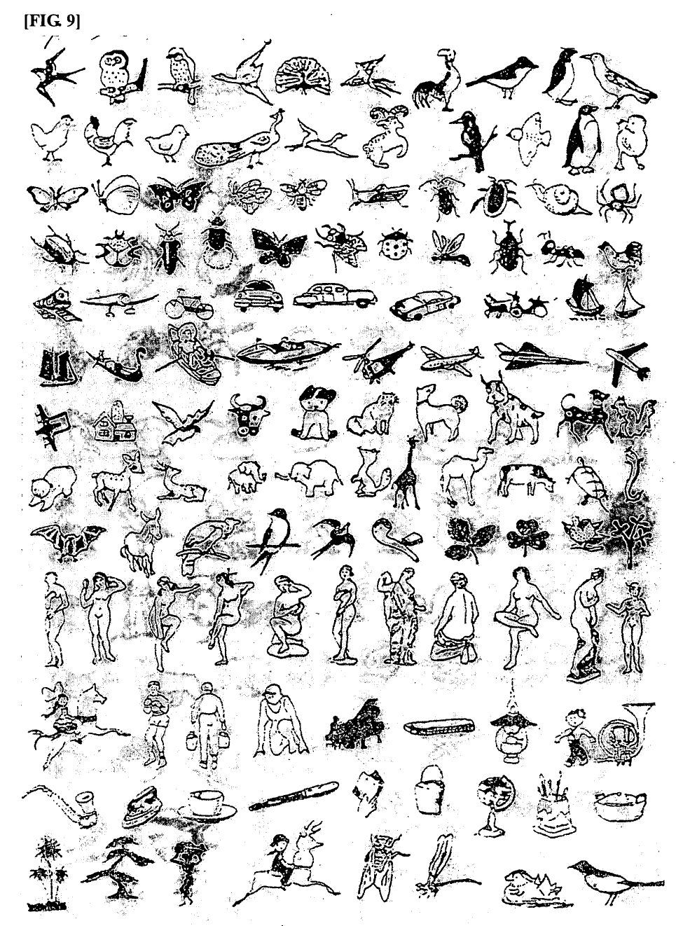

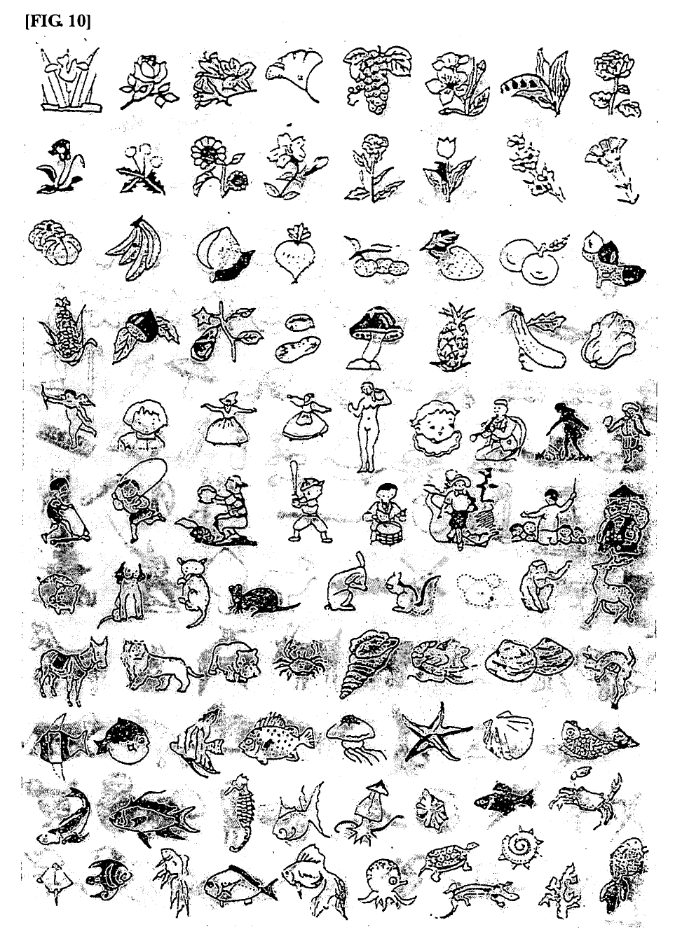

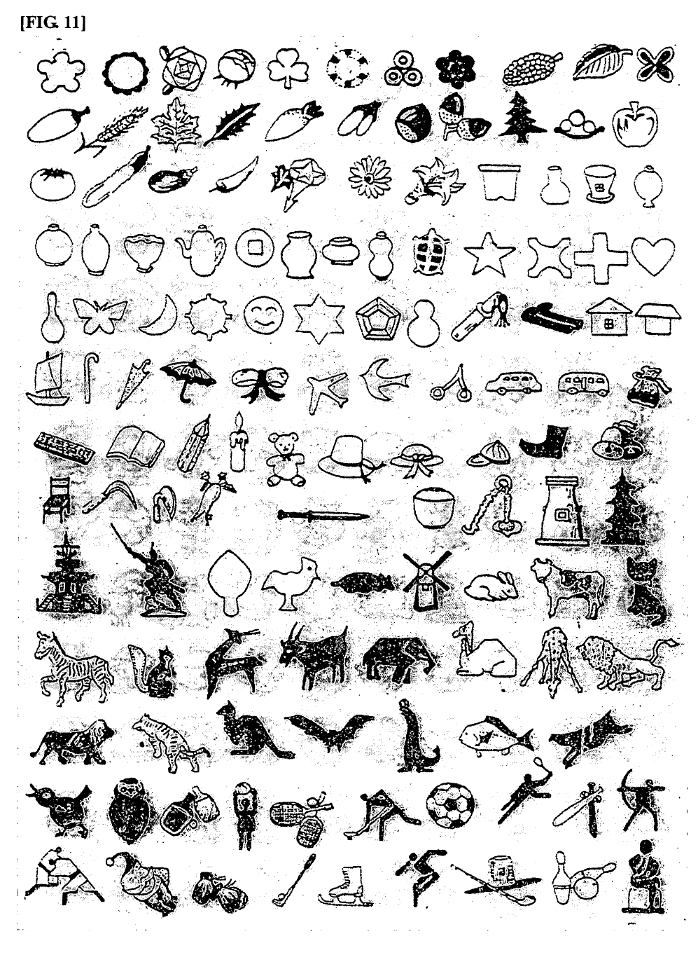

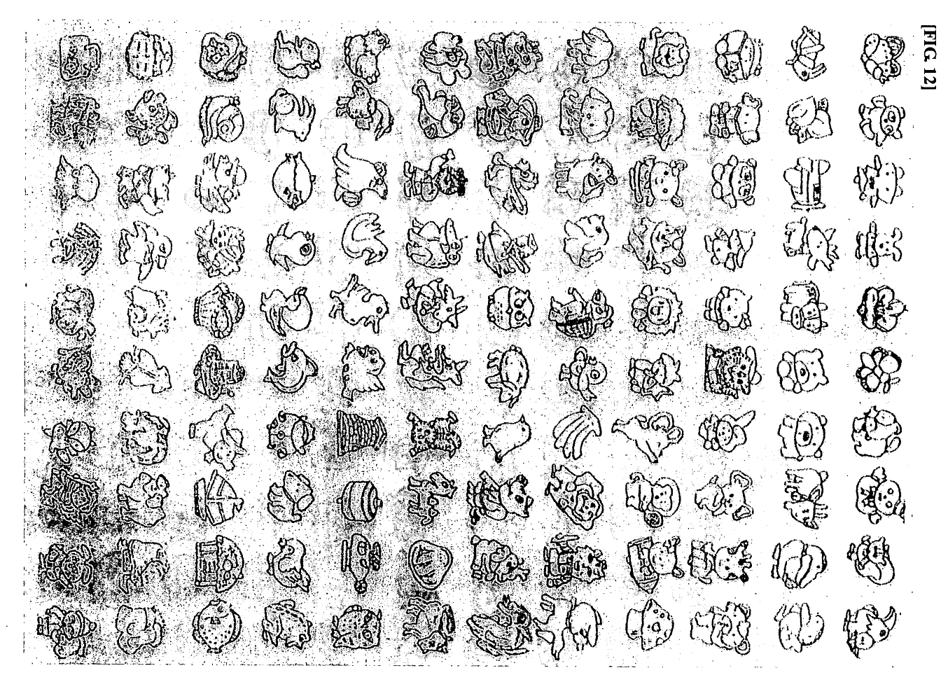

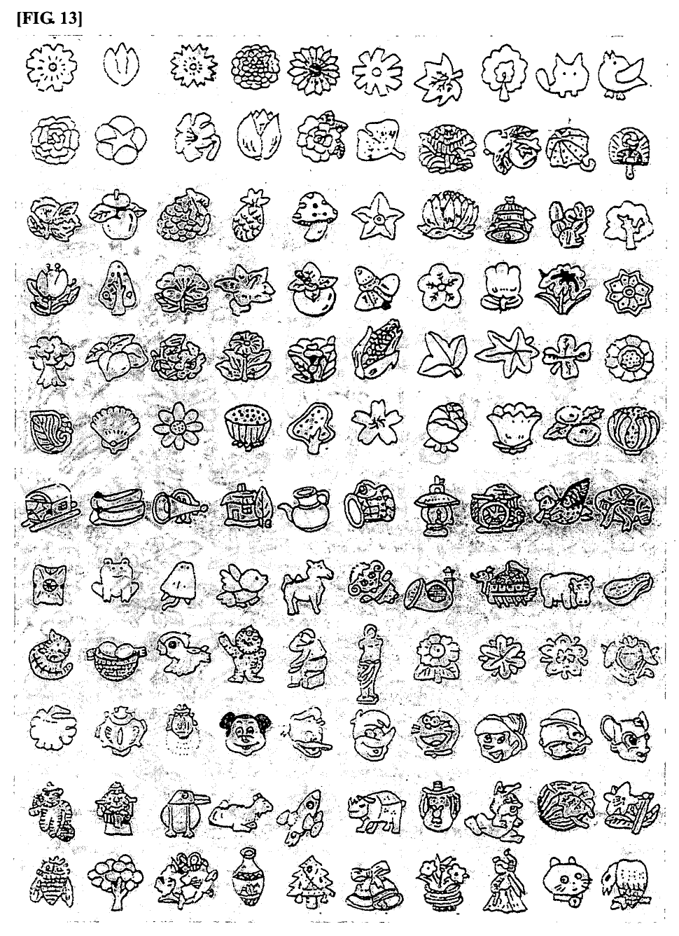

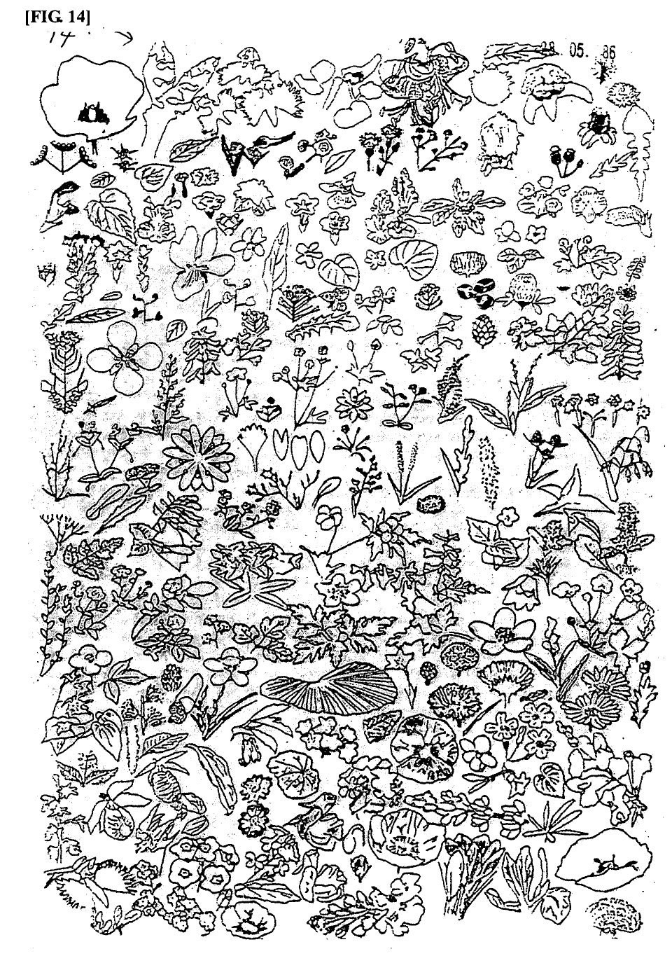

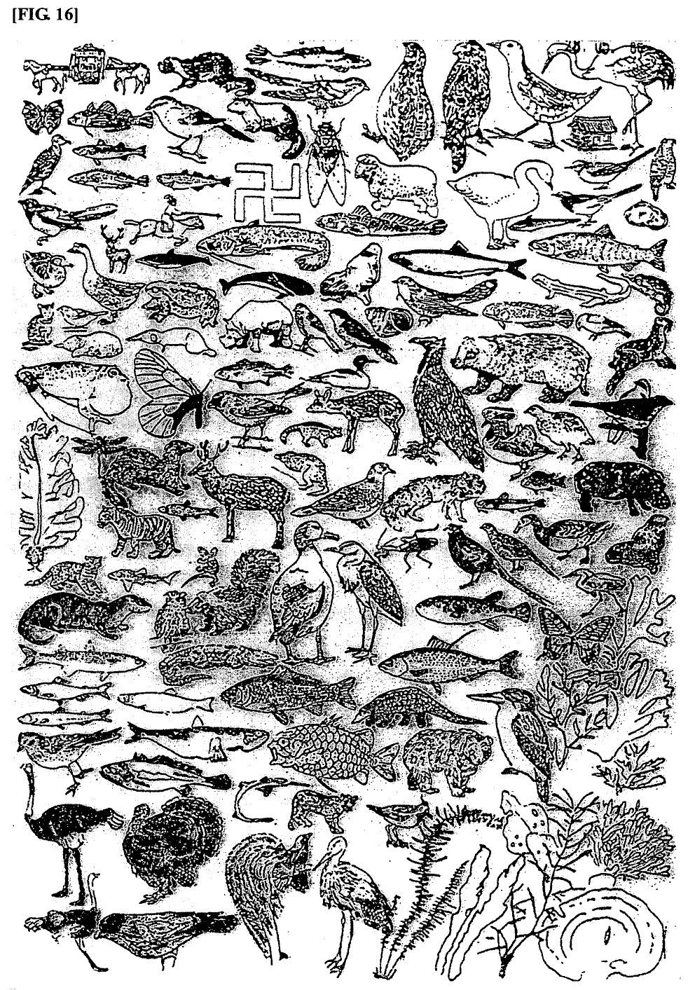

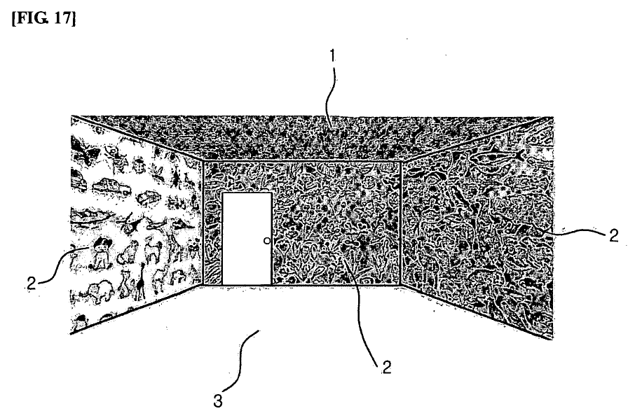

FIGS. 1 through 8 illustrate exemplary embodiments of a ceiling paper according to the present invention, and FIGS. 9 through 16 illustrate exemplary embodiments of wallpaper according to the present invention. FIG. 17 illustrates an embodiment of indoor decoration by using an indoor decorative paper of the invention. As shown in FIG. 17, the ceiling paper illustrated in FIG. 1 is pasted on the ceiling, and the wallpaper illustrated in FIGS. 9, 14 and 16 is pasted on walls.

Referring to FIGS. 1 through 8, the ceiling paper has no distinctive patterns in upper and lower parts. The pattern can be composed of a variety of designs and colors, or can be embossed. Moreover, the front surface of the ceiling paper can have one single color with no pattern. This type of ceiling paper has no distinction in every direction so it provides people with a feeling of stableness.

On the other hand, the wallpaper illustrated in FIGS. 9 through 16 has distinctive patterns between upper and lower parts. As shown in FIGS. 9 through 16, distinctive upper and lower patterns do not necessarily indicate that the patterns are all upside down or inclined, but indicate that the patterns are where they are supposed to be. Therefore, by decorating the walls and the ceilings with these wallpapers and ceiling papers, people feel more secure and are emotionally stable.

The patterns of the wallpaper can be composed of a variety of designs and colors, or one single color. Moreover, the front surface of the ceiling paper can have one single color with no pattern. Preferably, each of the patterns on the wallpaper is a different design, as illustrated in FIGS. 9 through 16. Therefore, by designing the front surface of the wallpaper with different patterns, people feel differently every time they see it, and as a result, they can refresh themselves.

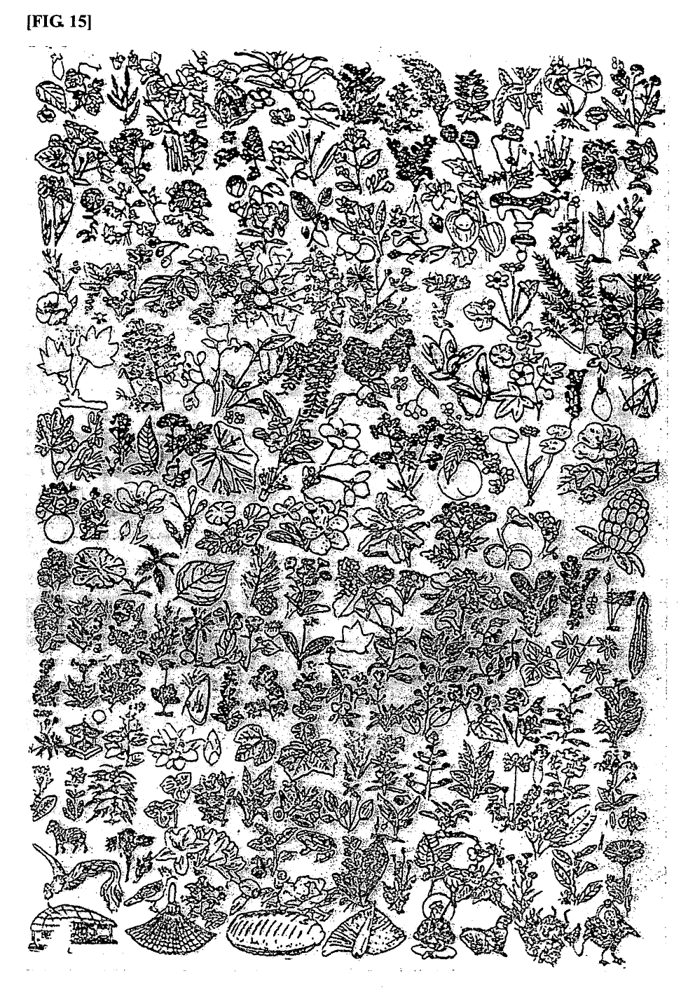

Although the patterns of the wallpaper are preferably composed of shapes of human beings, animals, and plants, in some cases, they can be plants or animals, as shown in FIGS. 14 and 15.

Preferably, the colors of the ceiling paper and the wallpaper can be the same, or harmonized, or contrasted. More preferably, the colors of the ceiling paper and the wallpaper can be diverse as many as possible.

The more diverse the designs and the colors are, the better and the more refreshing. Typically, the related art wallpaper or ceiling paper had no pattern or was simply embossed, which is more like painting the wall with one color. This type of wall usually gives people a feeling of monotonous, and people become emotionally dry. Worse than all, people did not have many options because most of the related art wallpapers or ceiling papers were like that.

The decorating method using the wallpaper and the ceiling paper according to the present invention includes pasting the wallpaper on the walls, and pasting the ceiling paper on the ceilings.

More specifically, an adhesive is applied to the rear surface of the wallpaper having distinctive patterns between upper and lower parts, and then the wallpaper is pasted on the walls.

Similarly, an adhesive is applied to the rear surface of the ceiling paper having no distinctive patterns between upper and lower parts or having no patterns, and then the ceiling paper is pasted on the ceilings.

Although the sequence is not important, preferably the wallpaper is first pasted and the ceiling paper is pasted later.

There is nothing better than wallpaper or ceiling paper to change the indoor decoration. With the application of the wallpaper and the ceiling paper of the present invention, people can enjoy different patterns, such as objects (including humans), characters, conceptual designs, and others, on the same wallpaper. Every time people see the wallpaper, they feel new yet friendly, and become more stable.

While the invention has been described in conjunction with various embodiments, they are illustrative only. Accordingly, many alternative, modifications and variations will be apparent to persons skilled in the art in light of the foregoing detailed description. The foregoing description is intended to embrace all such alternatives and variations falling with the spirit and broad scope of the appended claims.

1. An indoor decorative paper comprised of:
a wallpaper having distinctive patterns in upper and lower parts, and of which rear surface is coated with an adhesive and pasted on walls; and
a ceiling paper having no distinctive pattern between upper and lower parts, or having no patterns, and of which rear surface is coated with an adhesive and pasted on ceilings.

2. The indoor decorative paper according to claim 1, wherein a front surface of the ceiling paper has no patterns.

3. The indoor decorative paper according to claim 1, wherein patterns on the front surface of the ceiling paper are not distinctive between upper and lower parts.

4. The indoor decorative paper according to claim 1, wherein patterns on the front surface of the wallpaper are all different.

5. The indoor decorative paper according to claim 3, wherein at least two colors are used for the front surfaces of the wallpaper and the ceiling paper.

6. An indoor decoration method, comprising the steps of:
applying an adhesive to a rear surface of a wallpaper having distinctive patterns between upper and lower parts, and pasting the wallpaper on walls; and
applying an adhesive to a rear surface of a ceiling paper having no distinctive patterns between upper and lower parts, or having no patterns, and pasting the ceiling paper on ceilings.

7. The indoor decorative paper according to claim 2, wherein patterns on the front surface of the wallpaper are all different.

8. The indoor decorative paper according to claim 3, wherein patterns on the front surface of the wallpaper are all different.
